(19) United States
(12) Patent Application Publication
(10) Pub. No.: US 2009/0172714 A1
(43) Pub. Date: Jul. 2, 2009

(54) METHOD AND APPARATUS FOR COLLECTING METADATA DURING SESSION RECORDING

(76) Inventors: Harel Gruia, Qiryat Tiyon (IL); Maxim Romanov, Bnei Ayish (IL); Daniel Shimoff, Beit Shemesh (IL); Tsakhi Segal, Cupertino, CA (US)

Correspondence Address: GLENN PATENT GROUP, 3475 EDISON WAY, SUITE L, MENLO PARK, CA, 94025, US

(21) Appl. No.: 12/046,406

(22) Filed: Mar. 11, 2008

Related U.S. Application Data
(60) Provisional application No. 61/006,173, filed on Dec. 28, 2007.

(51) Int. Cl. G06F 9/44

(52) U.S. Cl. 719/331

(57) ABSTRACT

Text that appears in sessions presented on a computer screen is indexed to enable future text-based search of the session content. During the recording, a text capture algorithm is used to capture any text data presented on any window on the computer screen, either in a selective or in an all-encompassing manner. Data captured are indexed to the capture time because a timestamp must be known to allow for a search that can provide temporal relevance. The interval used to capture the window data is modifiable, based on the needs of the application. Once the window is scanned, a comparison is done with the results of previous captures to determine if there is a need to update the metadata database with new results.

### CROSS REFERENCE TO RELATED APPLICATIONS

This patent application claims the benefit of U.S. provisional patent application Ser. No. 61/006,173, filed on 28 Dec. 2007, and the entirety of which is incorporated herein by this reference thereto.

### BACKGROUND OF THE INVENTION

1. Technical Field

The invention relates generally to the field of search and more specifically to enabling the search of a session that is displayed on a computer screen, based on text components thereof, by means of collecting metadata.

2. Discussion of the Prior Art

The use of the World Wide Web (WWW) and browsers has become ubiquitous for many applications. In some applications, including remote learning, it is possible to provide users with one or more streams of data, presentations, documents, and video, referred to hereinafter as display content. This content has the nature of changing over time as slides change, documents are scrolled through, and video presents different views of, for example, whiteboards. The display content may be different between users depending on the number of windows they may open or other system capabilities or lack thereof. In many cases, the original display content is a result of a real-time stream of display content that is then made available off-line for future use and reference.

Accessing the stream of display content through a mechanism of referencing is desirable because it enables accessing a particular portion of the display content stream at a reference point, rather than having to view if from the beginning. Prior art solutions rely on the availability of information to provide such indexing and to access such content streams efficiently. Many times, such systems rely on the existence of metadata to provide such indexing information for the purpose of a search. The metadata is a type of data that describes other data. Garg, Automated knowledge management system, U.S. patent application Ser. No. 11/322,963 is an example of such a prior art. The system detects and extracts metadata from a plurality of sources. However, the metadata itself has to be produced somehow and made available to such engines. The problem is that the amount of data, especially in the case of a stream of displayed content is vast and difficult to index manually to create the necessary metadata.

In view of the limitations of the prior art, it would be therefore advantageous to provide a method that generates metadata for a stream of display content. It would be further advantageous if such a solution would work equally well on a single user basis, as well as for a plurality of users. It would be further advantageous if the solution can configure the process metadata creation to allow the selective creation of the metadata.

### SUMMARY OF THE INVENTION

An embodiment of the invention provides ability to index text that appears in sessions presented on a computer screen, and thus enables future text-based search of the session content. During the recording, a text capture algorithm is used to capture any text data presented on any window on the computer screen, either in a selective or all-encompassing manner. Data captured are indexed to capture time because a timestamp must be known to allow for a search that can provide temporal relevance. The interval used to capture the window data is modifiable, based on the needs of the application. Once the window is scanned, a comparison is done with the results of previous captures to determine if there is a need to update the metadata database with new results.

### BRIEF DESCRIPTION OF THE DRAWINGS

FIG. 1 is a flowchart depicting the principles of the disclosed invention.

FIG. 2 is an exemplary system implemented in accordance with the principles of the disclosed invention.

### DETAILED DESCRIPTION OF THE INVENTION

An embodiment of the invention provides a method and apparatus for indexing text that appears in sessions presented on a computer screen to enable future text-based search of the session content. During the recording, a text capture algorithm is used to capture any text data presented on any window on the computer screen, either in a selective or all-encompassing manner. Data captured are indexed to the capture time because the timestamp must be known to allow for a search that can provide temporal relevance. The interval used to capture the window data is modifiable, based on the needs of the application. Once the window is scanned, a comparison is done with the results of previous captures to determine if there is a need to update the metadata database with new results.

In one embodiment of the invention, the process for capturing metadata during the recording of sessions of streams of display content is based on the existence of two elements. The first element is a server that comprises components for enabling the management of the process as a whole. The second element is an injected dynamically linked library (DLL) that enables the extraction of data from within the window process itself as it appears during the period in which the stream of display content is provided to a user. In general, a DLL is an executable program that resides either on the server or on a user's machine, and that enables, typically in the Windows® environment, the performance of one or more desirable functions.

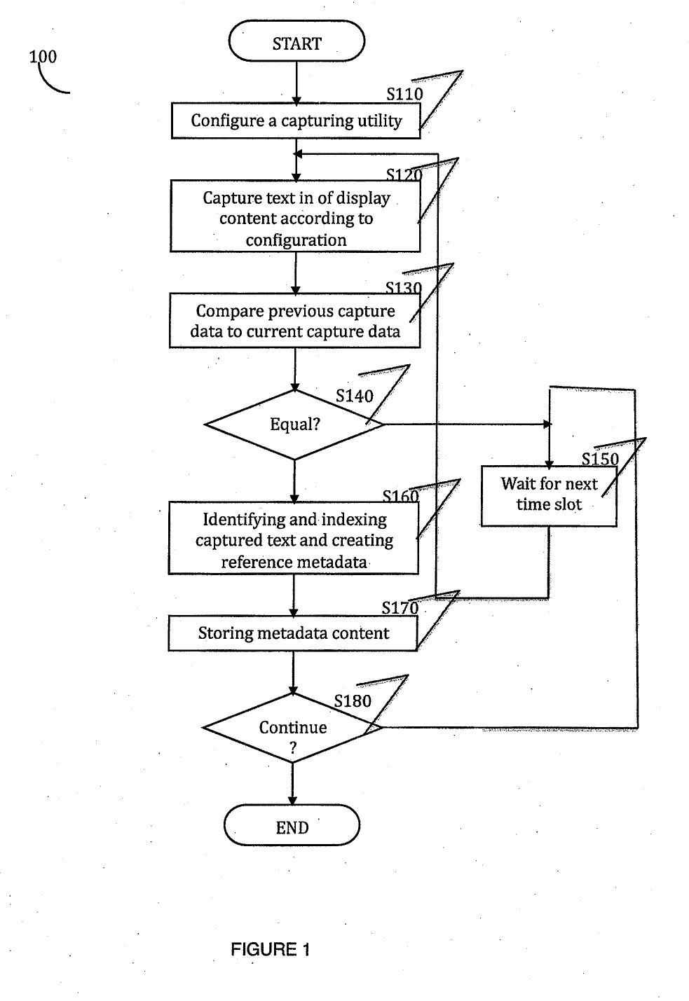

FIG. 1 is a flowchart 100 that describes the principles of the disclosed invention. In step S110, a capturing utility is configured to capture data in accordance with the invention. This may include creating a black list of windows that do not require capturing, a white list of windows that must be captured, types of data to be captured, time intervals for capturing, and the like.

In step S120, capturing of the desired portions of the display content takes place. Specifically, the text portions of the display content are identified for the purpose of indexing.

In step S130, the captured data are compared to captured data of a previous time slot, if such a previous time slot exists.

In S140 step, it is determined if the current captured data and the previous captured data are the same and, if so, execution continues with step S150; otherwise, execution continues with step S160.

In step S150, the method waits for the duration of a predetermined period of time and then continues execution with step S120.

In step S160, if it is determined that the current captured data is different from the previously captured data, the captured data is processed to identify text portions and to provide metadata that indexes these text portions relative to the timeslot during which they were captured.

In step S170, the list is saved in memory by adding the new metadata and corresponding timeslots to a list of previously determined metadata. In step S180, it is checked whether the session of the display content continues and, if so, execution continues with step S150; otherwise, execution terminates.

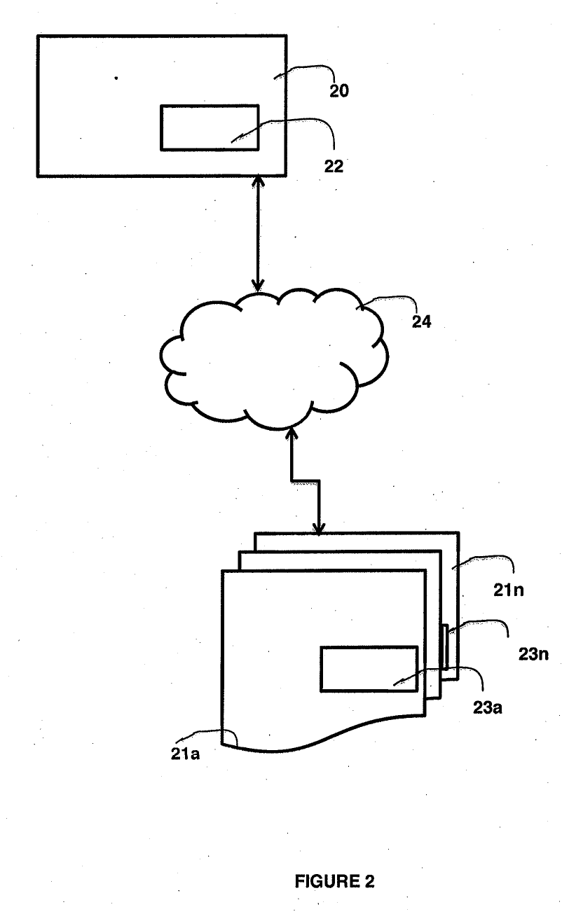

The invention shall now be further described from the view of an exemplary and non-limiting system, as shown in FIG. 2. The explanation herein is provided so as to better understand the principles of the invention, but by no means is it intended to limit the scope of the invention.

The text capture server 20 is the engine and the manager of the whole capture process. The tasks that it manages include:
a) managing the communication process between the server 20 and the client 21a-21n over a network 24;
b) injecting a DLL agent 23a-23n;
c) managing the communication between the DLL agent activated on the client computer; and
d) processing and filtering the raw text data accumulated at each time slot, and generating the metadata lists.

The management of the communication processes between the server and the client computer involves several non-limiting aspects to it:
a) returning text data from all child windows which belong to the given process;
b) returning text data from a given window, setting the server's white/black process list; and
c) setting the server's per process white/black win class list.

The server filter 22 component is used for processing and filtering the raw data as received from the various agent DLLs. The filter mechanism is responsible for determining whether the captured data is relevant or not by running several tests.

A black list process filter verifies that the agent reporting is not operating on a black-listed process type. Black listed process types are defined within the client application programming interface (API). It thereby allows the caller to remove specific process types from the metadata gathering.

A white list process filter is, in fact, the opposite of the black list process filter. If a white list is defined, data from agents reporting only from processes found on the white list have their data automatically accepted.

A window process filter allows the calling server to determine if there is a window within a particular process window that should be either captured or ignored. In a sense, this may be viewed as similar to using the black/white process filter on internal process entities.

An extraneous data filter is enabled to remove extraneous or repeated data extracted from within a process. This filter removes all but the initial set of data captured in the first time interval.

A conversion filter is enabled to convert all captured text into a single encoding system. This is performed, for example, by converting it to a wide-char, i.e. double-byte conversion. This aspect of the invention enables, for example, the support of multilingual applications.

In accordance with the principles of the invention, the text capture agent DLL is injected into the target process by the server. This action allows the agent to replace the operating system function calls that the process uses with specialized function calls that enable the capturing of the metadata, as disclosed hereinabove.

The teachings made hereinabove may be implemented in hardware, software, or firmware, or any combination thereof. Specifically, a computerized method may be implemented on a system (not shown) with instructions stored in a memory of a computer that comprises at least a processing unit, memory, and input and output interfaces.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computerize implemented method for indexing real-time computer displayed content, comprising the steps of:
using a dynamically linked library to record content displayed by a computer and to store said recorded content in a computer readable storage;
capturing text data associated with and/or contained in said content at selected, consecutive time intervals; and
saving the captured text in a computer readable storage in association with a time index;
wherein said text data is captured according to a selected configuration.

2. The method of claim 1, wherein said configuration enables selective capturing of said text data.

3. The method of claim 2, wherein said selective capturing comprises the step of capturing text data from less than all of said content.

4. The method of claim 1, further comprising the steps of:
comparing newly captured text data to previously captured text data; and
storing said newly captured text data if said newly captured text data is different from said previously captured text data.

5. The method of claim 1, further comprising the step of:
searching for a text in said computer readable storage.

6. The method of claim 5, wherein said searching for a text is text the occurs between a first time interval and a second time interval.

7. An apparatus for indexing real-time computer displayed content, comprising:
a dynamically linked library associated with a client computer for to recording content displayed by a computer and for storing said recorded content in a computer readable storage;
said dynamically linked library comprising a mechanism for capturing text data associated with and/or contained in said content at selected, consecutive time intervals; and
said dynamically linked library comprising a mechanism for saving the captured text in a computer readable storage in association with a time index;
wherein said text data is captured according to a selected configuration.
